(19) United States
(12) Patent Application Publication
(10) Pub. No.: US 2024/0307901 A1
(43) Pub. Date: Sep. 19, 2024

(54) ELECTROSTATIC POWDER COATING DEVICE AND RELATED COATING SYSTEM

(71) Applicant: Trasmetal S.p.A., Milano (IT)

(72) Inventor: Gianni Giardini, Milano (IT)

(21) Appl. No.: 18/607,981

(22) Filed: Mar. 18, 2024

(30) Foreign Application Priority Data
Mar. 16, 2023 (IT) 102023000004971

(51) Int. Cl. B05B 5/03; B05B 5/16

(52) U.S. Cl. CPC B05B 5/032; B05B 5/1683

(57) ABSTRACT

An electrostatic powder coating device comprises a shaped body extending along a longitudinal axis and housing an internal chamber configured to contain a fluid bed of powder coating. A closing plate of the internal chamber comprises a first intake duct of a powder coating into the internal chamber and a second intake duct of pressurized air into the internal chamber. The shaped body comprises first and second elements extending along the longitudinal axis, the first element comprising a first surface defining a lower portion of the internal chamber, the second element comprising a second surface defining an upper portion of the internal chamber connected to the first element. The first and second elements each comprise respective peripheral edges facing each other to form slits putting the internal chamber in communication with the outside of the shaped body, a plurality of electrodes arranged at the slits and connected to voltage generators.

### CROSS-REFERENCES TO RELATED APPLICATIONS

This application claims the benefit of Italian Patent Application No. 102023000004971, filed Mar. 16, 2023, and which is hereby incorporated by reference in its entirety.

### BACKGROUND

The present disclosure relates to an electrostatic coating device, and in particular to an innovative electrostatic coating device for the powder coating of artifacts.

As is known, to coat metal artifacts, for example panels or profiles, coating chambers are provided in which the artifact is introduced and passed, normally continuously, in front of electrostatic coating devices, typically guns or discs, which are positioned inside the chamber to carry out the coating of the artifact.

Normally, electrostatic coating devices can be moved along a vertical support whose axis is parallel to the vertical axis of the coating chamber. The upward or downward translation of the electrostatic disc allows the artifact to be coated in its entire height while maintaining transport continuity. However, if the artifact must be coated on multiple sides, it is necessary to resort to measures which allow the homogeneous coating thereof on all faces.

For example, if electrostatic coating guns are used, it is possible to envisage the use of banks of coating guns which operate in opposite directions along the transfer path so as to be able to coat all the outer surfaces of the artifact homogeneously. This necessarily involves a doubling of the number of guns needed for coating with a consequent notable increase in costs.

The problem of doubling the number of guns needed for coating also arises if the rotation of the pieces is envisaged after one side has been coated. Since the transport occurs continuously, it is in fact necessary to provide a second bank of guns along the transfer path, arranged on the same side as the first and in succession thereto, after the artifacts have been rotated to present the new side to be coated.

In any case, and with a further increase in costs, the rotation mechanisms of the pieces introduce further complications and are not always easy to implement, and the size of the booth must be increased as a consequence of the greater extension of the coating path therein.

If electrostatic coating discs are used, the artifact can be rotated around the disc, if only one disc is used, or, preferably, it follows a winding path around two or more electrostatic discs, so as to bring all its sides to face the edge of the electrostatic coating disc or discs.

The need is therefore felt to have electrostatic powder coating devices which are different from the existing electrostatic guns and discs, overcoming the problems of the known art.

### BRIEF SUMMARY

An exemplary object of an electrostatic powder coating device according to the present disclosure may be to carry out an adequate coating action on all the faces of an artifact.

Another exemplary object of an electrostatic powder coating device according to the present disclosure may be to keep the number of devices necessary inside the booth to obtain adequate coating of an artifact relatively limited.

Another exemplary object of an electrostatic powder coating device according to the present disclosure may be to limit the space necessary inside the booth, and consequently the development and surface of the booth itself.

Another exemplary object of an electrostatic powder coating device according to the present disclosure may be to provide a modular structure which can be easily adapted to operating needs.

Not least, an exemplary object of an electrostatic powder coating device according to the present disclosure may be high reliability and furthermore easy to manufacture and at competitive costs.

The above and other objects, as will appear from the following description, may be achieved via an electrostatic powder coating device according to the present disclosure and which comprises: a shaped body extending along a longitudinal axis and housing at least one internal chamber therein adapted to contain a fluid bed of a powder coating; a closing plate of the internal chamber transverse to the longitudinal axis and provided with at least a first duct for introducing a powder coating in the internal chamber and at least a second duct for introducing pressurized air in the internal chamber.

In the device according to the present disclosure, the shaped body may comprise: a first, lower element, extending along the longitudinal axis of the shaped body and comprising a first surface defining a lower portion of the internal chamber; a second, upper element, extending along the longitudinal axis of the shaped body and comprising a second surface defining an upper portion of the internal chamber.

Furthermore, in a device according to the present disclosure, the first and second element may each be provided with a first and second peripheral edge, respectively, delimiting one or more slits which put the internal chamber in communication with the outside of the shaped body, and a plurality of electrodes are arranged at the one or more slits and are connected to one or more voltage generators.

An electrostatic powder coating system may comprise a coating station provided with an electrostatic powder coating device as described herein.

Thereby, an electrostatic powder coating device is provided which may meet one or more of the above-mentioned objects.

In practice, as will better be seen in the following detailed description, the electrostatic coating device allows the coating to be implemented in a simple and effective manner on both only one side and on all sides of an artifact, without requiring the high overall number of devices necessary inside the coating booth which is typical in the known types of coating systems and keeping the path which the artifacts must travel relatively short.

Consequently, the space required inside the cabin, and therefore the total surface area occupied by it, is also relatively small.

Furthermore, as better described below, a single appropriately made and configured device can be sufficient to obtain an effective coating of the artifacts. In fact, the electrostatic coating device of the present invention, thanks also to its structure and its modularity features, can be made so as to comprise a plurality of internal chambers and a plurality of corresponding coating powder dispensing slits arranged in vertical succession along at least a part of its perimeter so as to satisfy different coating needs.

In particular, if the coating device comprises a plurality of internal chambers and a plurality of corresponding coating powder dispensing slits arranged in vertical succession, it is possible to modulate both the quantity of powder emitted and the electric charge imparted to the powder in a relatively simple manner. In fact, each slit is fed from an internal chamber thereof and it is therefore possible to activate/deactivate the emission of powder coating from each thereof simply by activating/deactivating the introduction of powder coating and air into each of them. Likewise, the polarisation of the coating powder emitted from each slit can be selectively activated/deactivated by simply activating/deactivating the power to the electrodes placed in each slit.

From an operating point of view, a device as disclosed herein may implement the known principles of electrostatic powder coating. In practice, a powder coating is introduced through the first intake duct into the internal chamber into which pressurized air is also introduced through the corresponding second intake duct, thus forming a fluid bed of powder inside the chamber. The powder coating then flows into the slit (or slits) formed by the peripheral edges of the first and the second element of the shaped body where it is polarised by the electric field generated by the electrodes arranged in the slit (or slits) and appropriately powered by the voltage generator(s), being therefore emitted outside in the direction of the artifacts to be coated.

In particular, in typical embodiments of a powder coating device as disclosed herein, the shaped body can advantageously comprise a first and a second substantially straight side which are opposite each other with respect to the longitudinal axis and parallel thereto. Furthermore, the first and the second side may be connected to each other, at one of their ends, by a front portion of the shaped body, which is preferably curved, and are connected to the closing plate at one of their ends which is opposite with respect to the curved portion.

In other words, the shaped body can advantageously be formed by a parallelepiped body closed on one side by the closing plate and delimited on the side opposite the plate by a front portion, preferably a cylinder portion. However, other geometries are possible.

Typically, in the various embodiments, the slit, or slits, for emitting the powder from each chamber are positioned on opposite sides with respect to the longitudinal axis of the shaped body and preferably also on the front side. In particular, the slit, or slits, for emitting the powder from each chamber are at least partly advantageously positioned in a plane parallel to the longitudinal axis of the shaped body and on opposite sides with respect to the axis, and preferably also on the front side.

In practice, if the shaped body is formed by a parallelepiped body as previously described, the one or more slits for emitting the powder from the internal chambers comprise a first and a second substantially straight slit portion which are positioned in a plane parallel to the longitudinal axis of the shaped body on a first and a second side which are substantially straight and opposite each other with respect to the longitudinal axis of the shaped body.

Furthermore, preferably, the slit or slits for emitting the powder from the internal chambers comprise a third slit portion which is positioned on the third front portion of the shaped body and which is connected to the first and a second slit portion.

Preferably the first, second and third slit portions are connected to each other to form a continuous slit which runs along at least a part of the external surface of the shaped body. Alternatively, the first, second and third slit portions can be separated, thus forming a series of slits which are substantially aligned with each other, running along at least a part of the external surface of the shaped body and connect a corresponding internal chamber of the shaped body with the exterior in an interspersed manner.

In some embodiments of an electrostatic powder coating device as disclosed herein, the shaped body comprises at least a third, intermediate element, extending along the longitudinal axis of the shaped body and which is interposed between the first and second element.

In these embodiments, at least a third element is connected to the first element and defines a first internal chamber therewith. At least a third element, which can be the same or different from the previous one, is also connected to the second element of the shaped body and defines a second internal chamber therewith.

Furthermore, the at least a third element connected to the first element is provided with a third peripheral edge facing the first peripheral edge of the first element to form one or more slits which put the first internal chamber in communication with the outside of the shaped body.

The at least a third element connected to the second element is provided with a fourth peripheral edge facing the second peripheral edge of the second element to form one or more slits which put the second internal chamber in communication with the outside of the shaped body.

A plurality of electrodes are further arranged at the one or more slits of the first and second internal chamber and are connected to one or more voltage generators.

In particular, in some embodiments of a device as disclosed herein, the third, intermediate element can advantageously comprise: a third surface defining an upper portion of the first internal chamber and which is shaped in a similar manner to the second surface of the second, upper element; and a fourth surface defining a lower portion of the second internal chamber and which is shaped in a similar manner to the first surface of the first, lower element.

It is thereby possible to create a modular structure in which the shaped body of the coating device comprises a series of internal chambers adapted to contain a fluid bed of coating powder which are superimposed on each other in a vertical direction and which have the same structure.

In practice, by directly coupling the first, lower element with the second, upper element, a device is obtained which is provided with a single internal chamber equipped with the corresponding one or more slits.

By using a single intermediate element, it is possible to obtain a device provided with a first and second internal chamber—each provided with corresponding one or more slits—by coupling the third intermediate element with the first, lower element and by coupling the same third intermediate element with the second, upper element.

By using a plurality of the third intermediate elements, superimposed and coupled in succession with each other according to needs, a plurality of internal chambers of the shaped body are instead created which are provided with corresponding one or more slits for the emission of polarised powder coating outwards.

In typical embodiments of an electrostatic powder coating device as disclosed herein, each of the internal chambers present in the shaped body can comprise a porous partition dividing them into a first and a second chamber portion. In these cases, the first powder coating intake duct is connected to the first portion and the second pressurized air intake duct is connected to the second portion.

In practice, in the first chamber portion the fluid bed of powder coating is created which is fed by the powder introduced through the first intake duct and by the pressurized air flowing through the porous partition after being introduced into the second chamber portion through the second intake duct.

In embodiments of an electrostatic powder coating device as disclosed herein, the closing plate of the internal chamber is provided with a third air intake duct at the plurality of electrodes, the function of which is to cool the electrodes positioned at the powder emission slit (or slits).

### BRIEF DESCRIPTION OF THE SEVERAL VIEWS OF THE DRAWINGS

Further features and advantages of various embodiments of an electrostatic powder coating device as disclosed herein may be illustrated by way of non-limiting example in the accompanying Figures.

FIG. 1 illustrates a perspective view of a first embodiment of an electrostatic powder coating device as disclosed herein.

FIG. 1a illustrates a perspective view of an embodiment of a shaped body of the electrostatic powder coating device of FIG. 1.

FIG. 2 illustrates a first longitudinal section view of the embodiment of the shaped body of the electrostatic powder coating device of FIG. 2.

FIG. 3 illustrates a second cross-sectional view of the embodiment of the shaped body of the electrostatic powder coating device of FIG. 2.

FIG. 4 illustrates a cross-sectional view of a first component of a general embodiment of an electrostatic powder coating device as disclosed herein.

FIG. 5 illustrates a cross-sectional view of a second component of a general embodiment of an electrostatic powder coating device as disclosed herein.

FIG. 6 illustrates a cross-sectional view of a third component of a particular embodiment of an electrostatic powder coating device as disclosed herein.

FIG. 7 illustrates a first cross-sectional view of a second embodiment of an electrostatic powder coating device as disclosed herein.

FIG. 8 illustrates a second longitudinal section view of a second embodiment of an electrostatic powder coating device as disclosed herein.

FIG. 9 illustrates a perspective view of a second embodiment of an electrostatic powder coating device as disclosed herein.

FIG. 10 illustrates a first cross-sectional view of a third embodiment of an electrostatic powder coating device as disclosed herein.

FIG. 11 illustrates a second longitudinal section view of a third embodiment of an electrostatic powder coating device as disclosed herein.

FIG. 12 illustrates a perspective view of a third embodiment of an electrostatic powder coating device as disclosed herein.

FIG. 13 illustrates a side view of a particular installation form of an electrostatic powder coating device as disclosed herein, in a coating station of an electrostatic powder coating system.

FIG. 14 illustrates a top view of a particular installation form of an electrostatic powder coating device as disclosed herein, in a coating station of an electrostatic powder coating system.

FIG. 15 illustrates a first cross-sectional view of a fourth embodiment of an electrostatic powder coating device as disclosed herein.

FIG. 16 illustrates a second sectional view on the horizontal lying plane of the electrodes of a fourth embodiment of an electrostatic powder coating device as disclosed herein.

### DETAILED DESCRIPTION

With reference to the accompanying Figures, in its most general embodiment, an electrostatic powder coating device 1, 10, 100, 110 comprises a shaped body 2, 20, 200, 210 extending along a longitudinal axis 3.

The shaped body 2, 20, 200, 210 houses at least one internal chamber 4, 41, 42, 43 therein which is intended to contain a fluid bed of a powder coating. At one end of the internal chamber 4, 41, 42, 43 is positioned, transversely with respect to the longitudinal axis 3, a closing plate 5, 51 which is provided with a first intake duct 6 of a powder coating into the internal chamber 4, 41, 42, 43 and a second intake duct 7 of pressurized air into the internal chamber 4, 41, 42, 43.

The shaped body 2, 20, 200, 210 comprises a first, lower element 21, extending along its longitudinal axis 3 and comprising a first surface 211 defining a lower portion of the internal chamber 4, 41. The shaped body 2, 20, 200, 210 also comprises a second, upper element 22, extending along its longitudinal axis 3 and comprising a second surface 221 defining an upper portion of the internal chamber 4, 42.

The first 21 and the second 22 elements are each respectively provided with a first 111 and second 112 peripheral edge defining one or more slits 8 for emitting the powder coating which put the internal chamber 4, 41, 42 in communication with the outside of the shaped body 2, 20, 200, 210. Furthermore, a plurality of electrodes 9 are arranged at the one or more slits 8 and are connected to one or more voltage generators (not shown).

In general, from an operating point of view, a powder coating is introduced into the internal chamber 4, 41, 42, 43 through the first powder intake duct 6. Optionally, pressurized auxiliary air can be introduced together with the powder through a further duct 74 positioned on the closing plate 5, 51.

Pressurized air is introduced into the internal chamber 4, 41, 42, 43 through the corresponding second intake duct 7, thus forming a fluid bed of powder inside the chamber 4, 41, 42, 43. The powder coating then flows into the slit (or slits) 8 where it is polarised by the electric field generated by the electrodes 9 arranged in the slit (or slits) 8, then being emitted outside in the direction of the artifacts to be coated. The electrical connection between the electrodes 9 and the one or more voltage generators is carried out by means of appropriate electrical connection elements 75 which are positioned on the closing plate 5, 51.

The general principles of electrostatic powder coating are widely known and will not be described further.

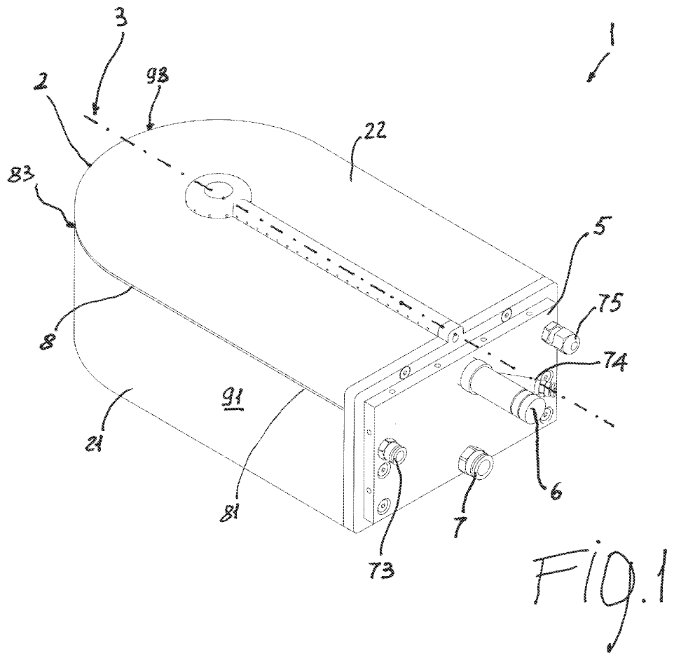

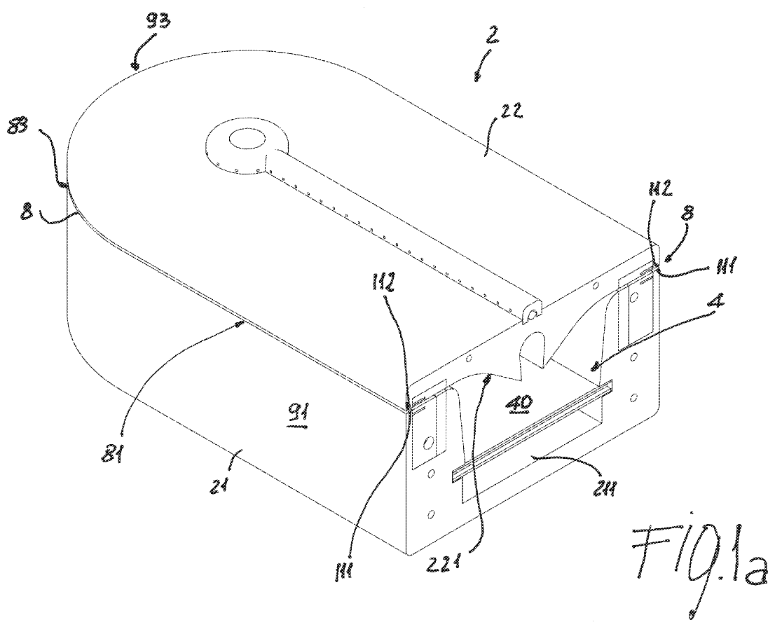

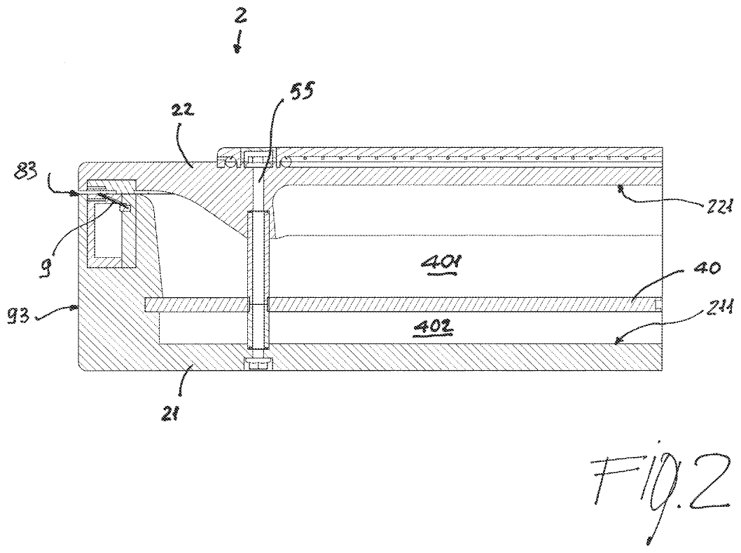

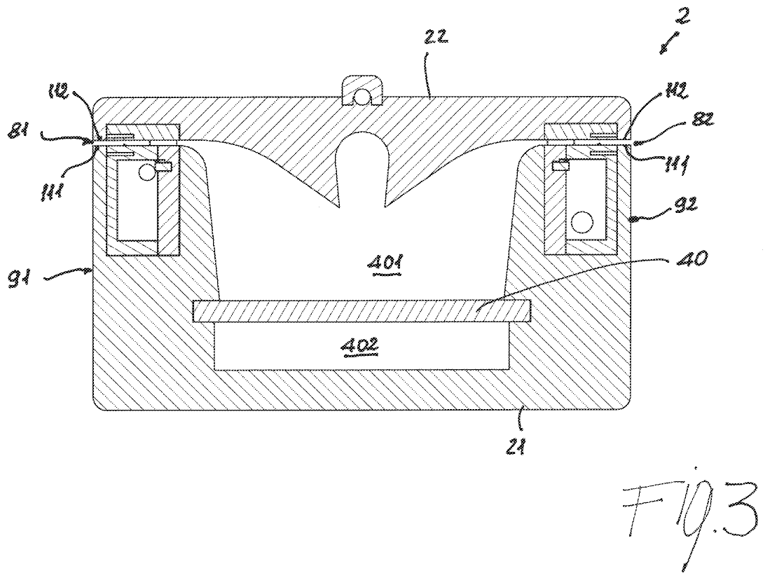

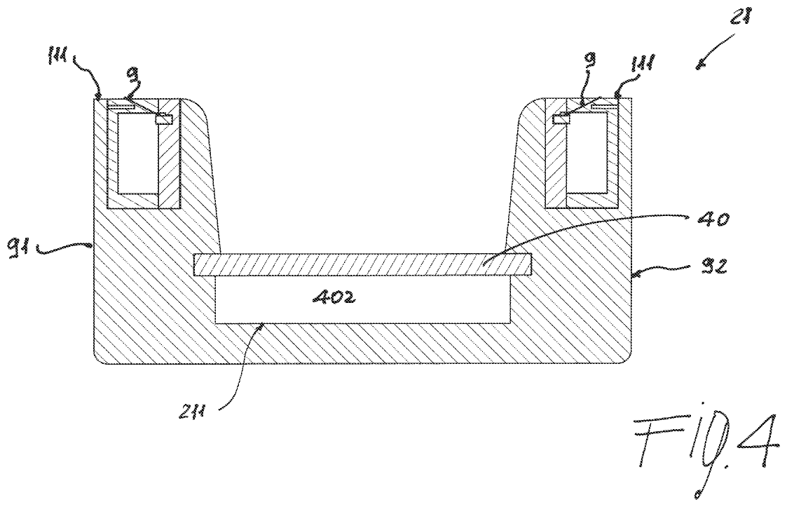

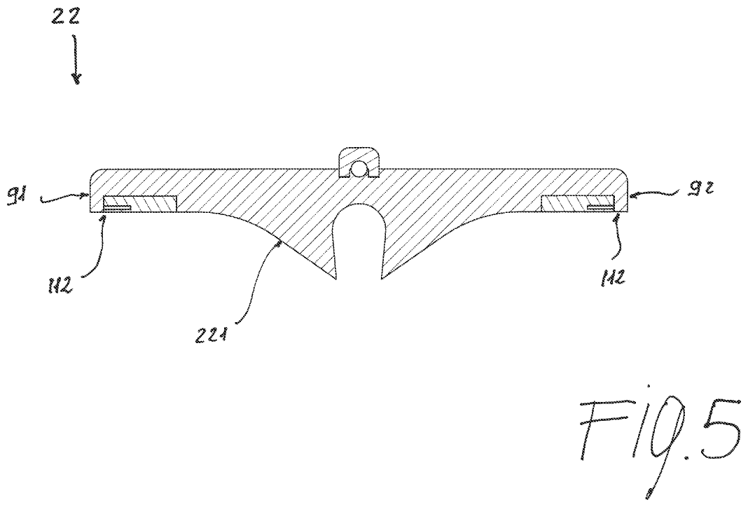

In a first embodiment of the present invention, illustrated with reference to FIGS. 1 to 5, the first lower element 21 of the shaped body 2 is directly connected to the second upper element 22 to form the shaped body 2 and define the corresponding internal chamber 4.

In this embodiment, the first peripheral edge 111 of the first element 22 of the shaped body 2 directly faces the second peripheral edge 112 of the second element 22 so as to form the slit 8 for emitting the powder. The slit 8 can be continuous or divided into two or more portions, as better described below.

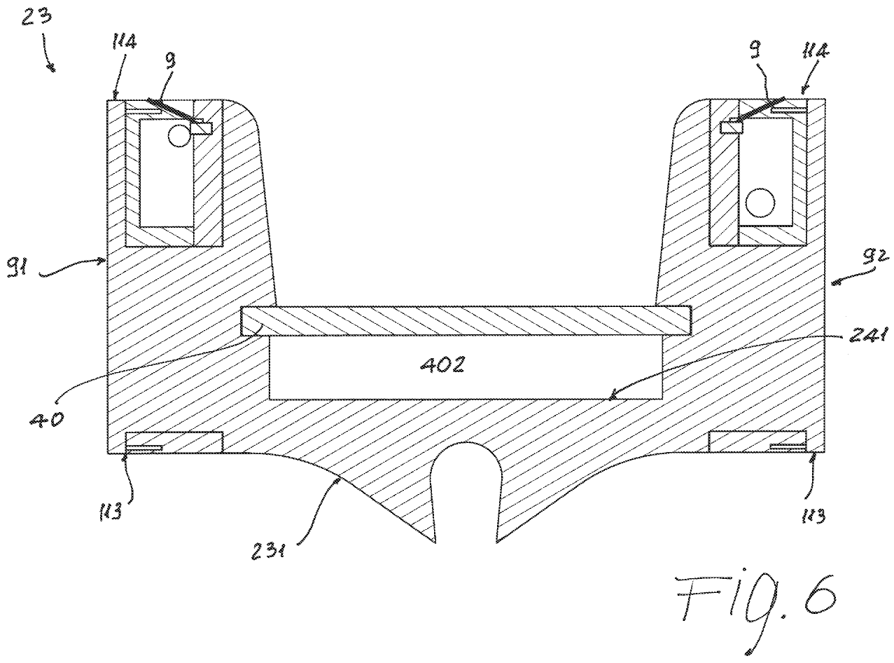

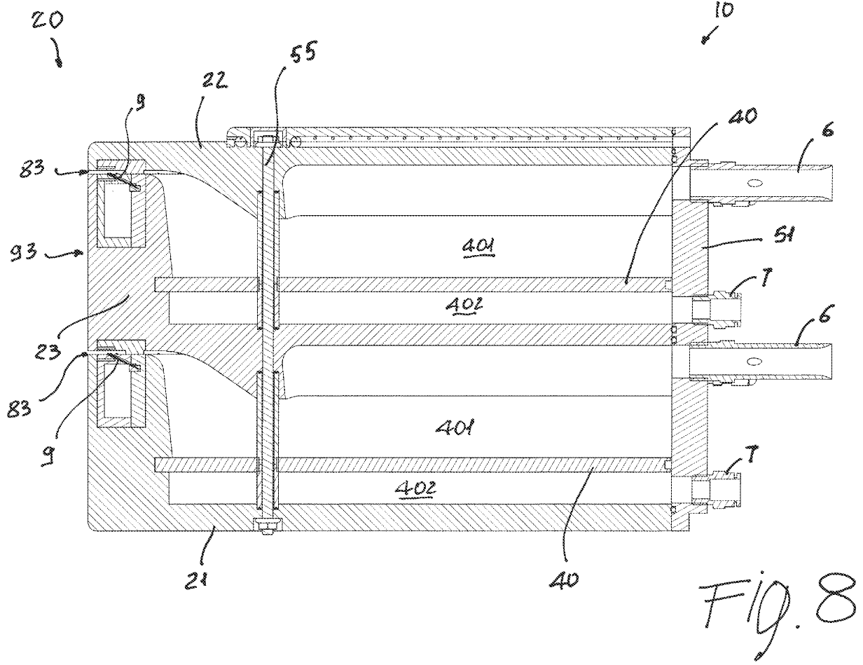

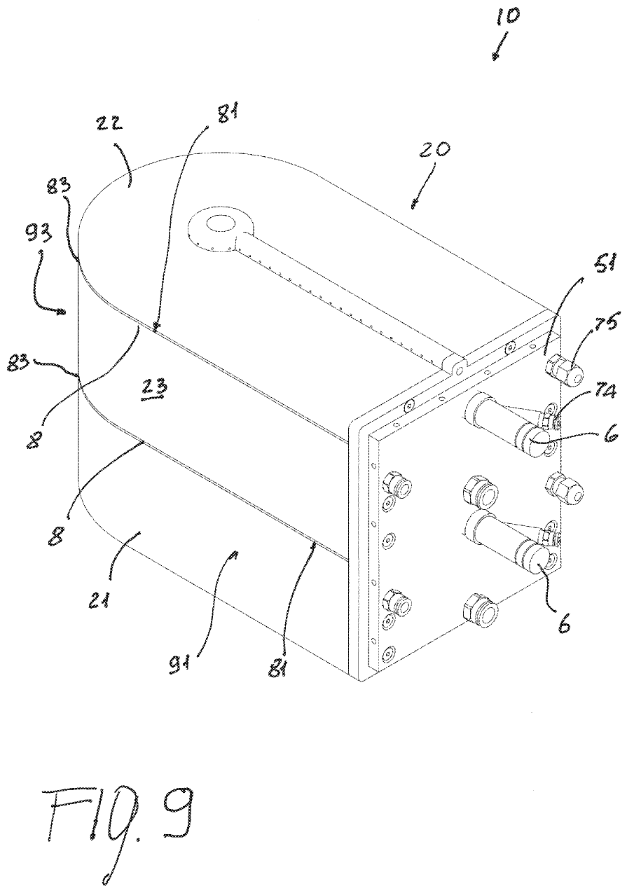

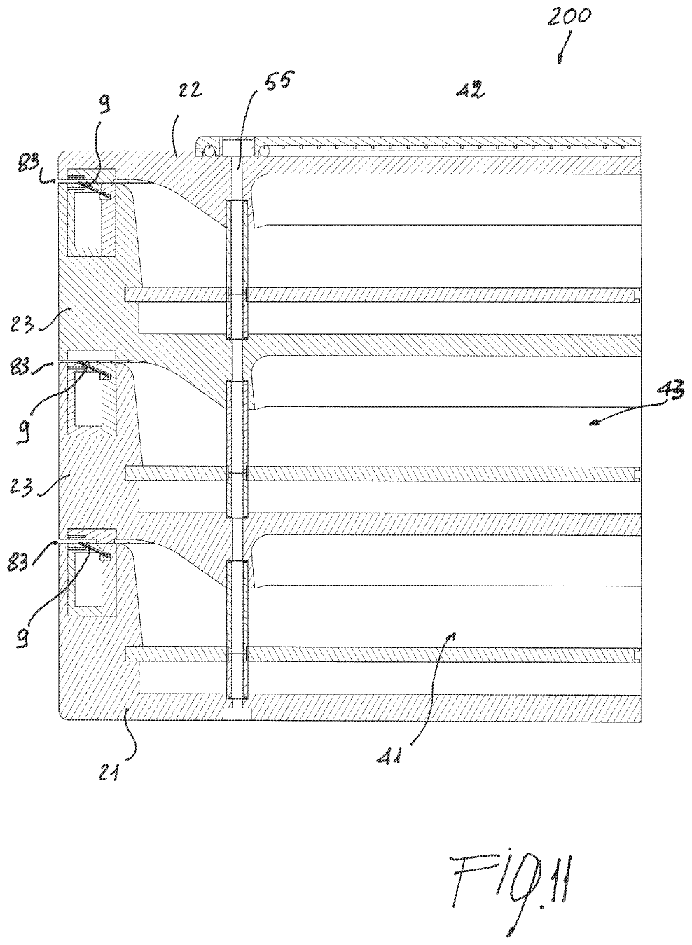

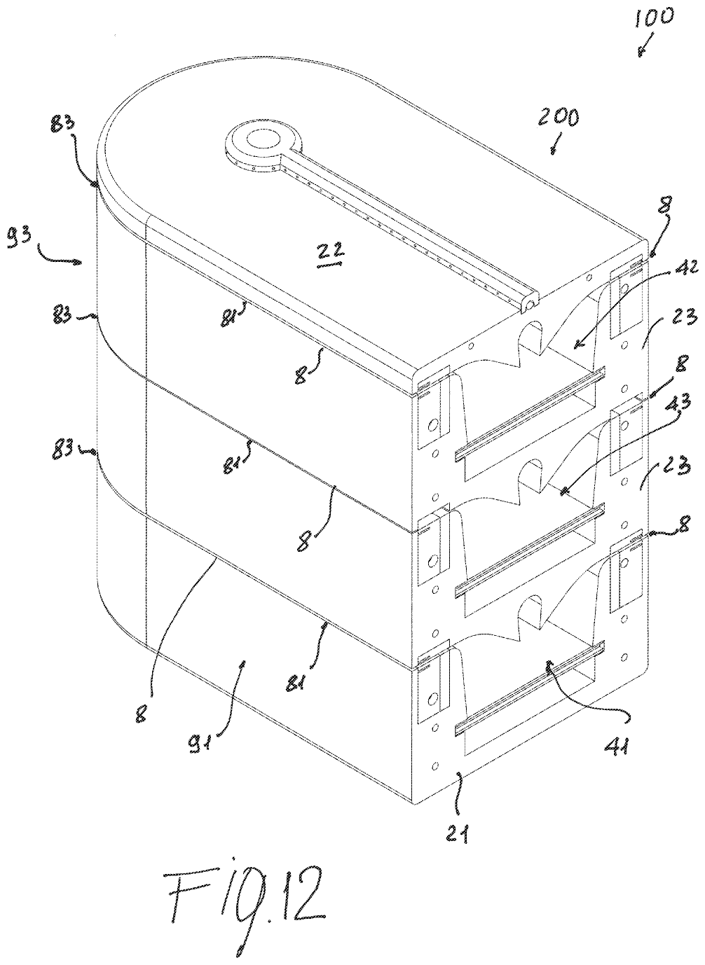

Starting from this basic configuration of a coating device as disclosed herein, it is possible to create further configurations, described with reference to FIGS. 6-12 and 15-16, according to a modular structure which allows such a device to be adapted to different application needs.

In detail, in the embodiments of FIGS. 6-12 and 15-16, the electrostatic powder coating device 10, 100, 110 as disclosed herein comprises a shaped body 20, 200, 210 essentially formed by the first lower element 21 and second upper element 22 and one or more third intermediate elements 23.

The third intermediate element 23 also extends along the longitudinal axis 3 of the shaped body 20, 200 and is interposed between the first 21 and second 22 element.

At least a third element 23 is connected to the first element 21 and defines a first internal chamber 41 therewith and at least a third element 23 is connected to the second element 22 and defines a second internal chamber 42 therewith.

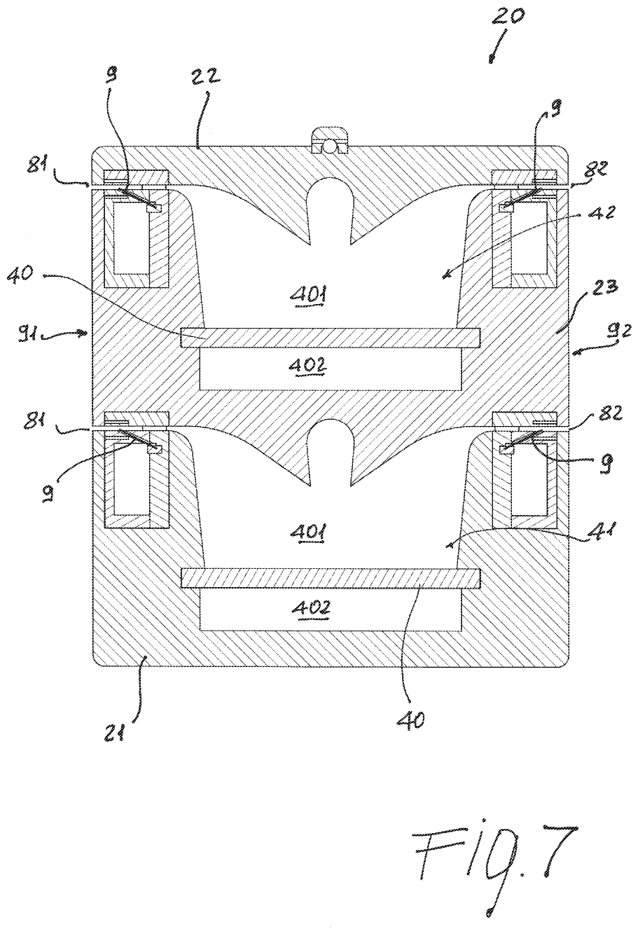

In the embodiments of FIGS. 7-9 and 15-16, a single third intermediate element 23 is interposed between the first lower element 21 and the second upper element 22 and is connected thereto—by means of, for example, the connection means 55—to form the first 41 and the second 42 internal chamber, each provided with corresponding one or more slits 8.

More in general, the electrostatic powder coating device of the present invention can comprise a plurality of the third intermediate elements 23, superimposed on each other and coupled in succession so as to define a plurality of internal chambers 43 of the shaped body provided with corresponding one or more slits 8.

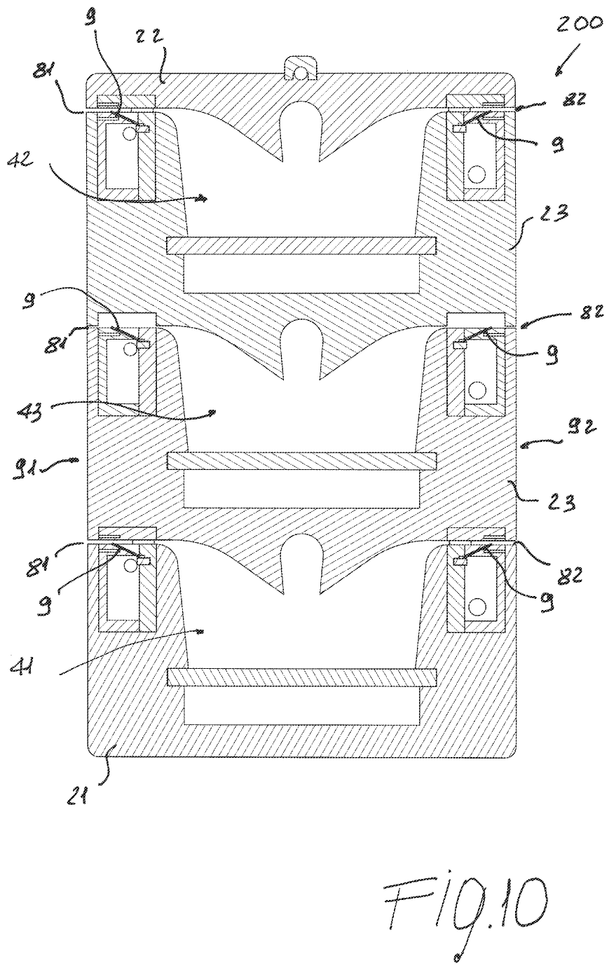

For example, with reference to FIGS. 10-12, using two intermediate elements 23 interposed between the first lower element 21 and the second upper element 22 of the shaped body 200, and connected thereto—by means of, for example, the connection means 55-a structure is obtained which is provided with a first 41, a second 42 and a third 43 internal chamber equipped with corresponding slits 8.

Again with reference to FIGS. 6-12 and 15-16, the third intermediate element 23 (or one of the third elements 23 when present in a number greater than one) is provided with a third peripheral edge 113 facing the first peripheral edge 111 of the first lower element 21 of the shaped body 20, 200 to form one or more slits 8 which put the first internal chamber 41 in communication with the outside of the shaped body 20, 200, 210.

The third intermediate element 23 (or another of the third elements 23 when present in a number greater than one) is also provided with a fourth peripheral edge 114 facing the second peripheral edge 112 of the second upper element 22 to form one or more slits 8 which put the second internal chamber 42 in communication with the outside of the shaped body 20, 200, 210.

As illustrated in FIGS. 10-12, if there are two or more third intermediate elements 23 superimposed in succession, the slits 8 of the intermediate chambers 43 are formed by the peripheral edges 113, 114 of the third intermediate elements 23 defining the intermediate chambers 43.

With reference to FIG. 6, each third intermediate element 23 is shaped so as to comprise a third surface 231 defining an upper portion of one of the first 41 or third 43 internal chambers. In particular, the third surface 231 of the third intermediate element 23 is advantageously shaped in a similar manner to the second surface 221 of the second upper element 22. Furthermore, each third intermediate element 23 is shaped so as to comprise a fourth surface 241 defining a lower portion of one of the second 42 or third 43 internal chamber. Advantageously, the fourth surface 241 is shaped in a similar manner to the first surface 211 of the first lower element 21, thus allowing the creation of a series of chambers having the same structure.

In particular, in the embodiment of FIGS. 7-9 and 15-16, the third intermediate element 23 comprises a third surface 231 defining an upper portion of the first internal chamber 41, the third surface 231 being shaped in a manner similar to the second surface 221 of the second upper element 22. The third intermediate element 23 further comprises a fourth surface 241 defining a lower portion of the second internal chamber 42, the fourth surface 241 being shaped in a similar manner to the first surface 211 of the first lower element 21. It follows that the structures of the resulting first 41 and second 42 internal chambers are therefore equal to each other.

Similarly, as is evident from FIGS. 10-12, if several intermediate elements 23 are present, by virtue of the same shape of the first 211 and fourth 241 surfaces and of the second 221 and third 231 surfaces, the structures of the internal chambers 41, 43, and 42 of the shaped body 200 are identical to each other and repeated in succession.

With reference to the accompanying figures, in various embodiments of the electrostatic powder coating device 1, 10, 100, 110 of the present invention, the shaped body 2, 20, 200, 210 comprises a first 91 and a second 92 substantially straight side which are opposite each other with respect to the longitudinal axis 3 and which are parallel thereto.

The first 91 and the second 92 sides are connected to each other at one end by a front portion 93 of the shaped body 2, 20, 200, 210 and are connected to the closing plate 5, 51 at one of their ends which is opposite with respect to the front portion 93.

The front portion 93 can have different geometries, for example it can be formed by a straight side perpendicular to the first 91 and second 92 sides, or a polygonal side made in the form of successive straight segments. Preferably, as illustrated in the accompanying Figures, the front portion is made in the form of a circumferential arc 93.

In practice, in these embodiments, the shaped body 2, 20, 200, 210 is formed by a parallelepiped body delimited by a first 91 and a second 92 side parallel to each other and by an upper surface and a lower surface. The parallelepiped body is closed, transversely with respect to the longitudinal axis 3, at one end by the closing plate 5, 51 and is delimited on the side opposite the plate 5, 51 by the front portion 93, which is preferably a cylinder portion.

As can be seen from the Figures, in these embodiments of the electrostatic powder coating device 1, 10, 100, 110 the slits 8 of the various internal chambers 4, 41, 42, 43 comprise a first 81 and a second 82 substantially straight slit portion which are positioned on each of the first 91 and second 92 sides of the shaped body 2, 20, 200, 210.

In other words, if the shaped body 2, 20, 200, 210 is formed by a parallelepiped body as previously described, the slits 8 for emitting the powder from the corresponding internal chambers 4, 41, 42 and 43 comprise a first 81 and a second 82 substantially straight slit portion which are positioned in a plane parallel to the longitudinal axis 3 of the shaped body 2, 20, 200, 210 on a first 91 and a second 92 substantially straight side thereof which are opposite each other with respect to the longitudinal axis 3 of the shaped body 2, 20, 200, 210.

The slits 8 of the internal chambers 4, 41, 42, 43 further comprise a third slit portion 83 which is positioned on the front curved portion 93 of the shaped body 2, 20, 200, 210. In the embodiments illustrated in the accompanying Figures, the first 81, second 82 and third 83 portion of each slit 8 for each internal chamber 4, 41, 42, 43 are connected to each other to form a continuous slit running uninterruptedly along at least a part of the extension of the first side 91, the second side 92 and the front portion 93 of the shaped body 2, 20, 200, 210.

Typically, in the electrostatic powder coating device 1, 10, 100, 110 of the invention, each of the internal chambers 4, 41, 42, 43 comprises a porous partition 40 dividing them into a first 401 and a second 402 internal chamber portion.

The first intake duct 6 of powder coating is connected to the first upper portion 401 of the internal chamber 4, 41, 42, 43 while the second intake duct 7 of pressurized air is connected to the second lower portion 402 of the internal chamber 4, 41, 42, 43. Inside the first, upper portion 401 of the internal chamber 4, 41, 42, 43 where the fluid bed of powder coating is created—and more precisely near its top—the slit 8 is located, from which the powder coating is projected outwards and towards the artifacts to be coated.

Normally, in the electrostatic powder coating device 1, 10, 100, 110, the closing plate 5, 51 of the various internal chambers 4, 41, 42, 43 is provided with a third intake duct 73 of cooling air at the plurality of electrodes 9.

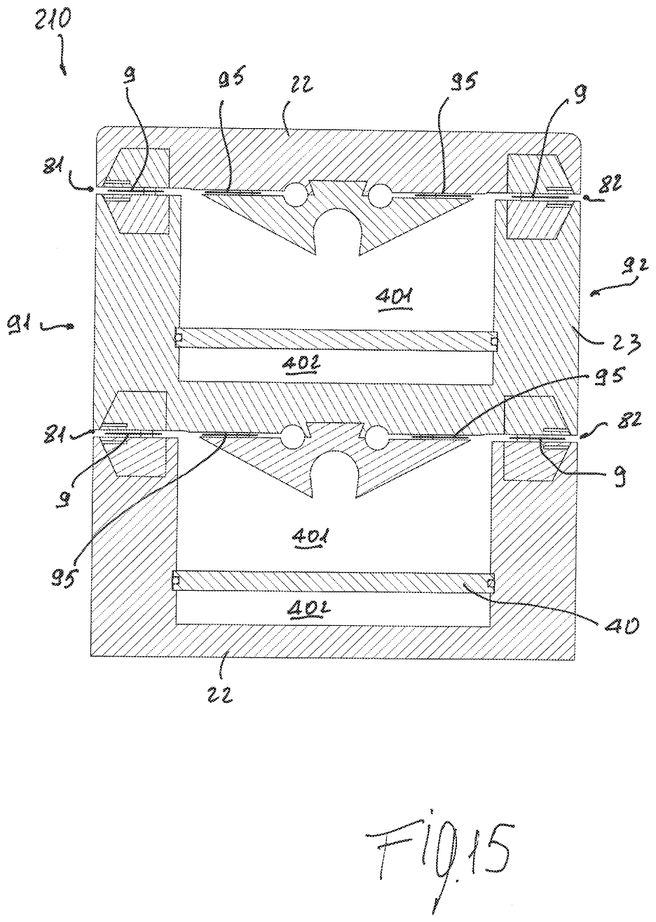

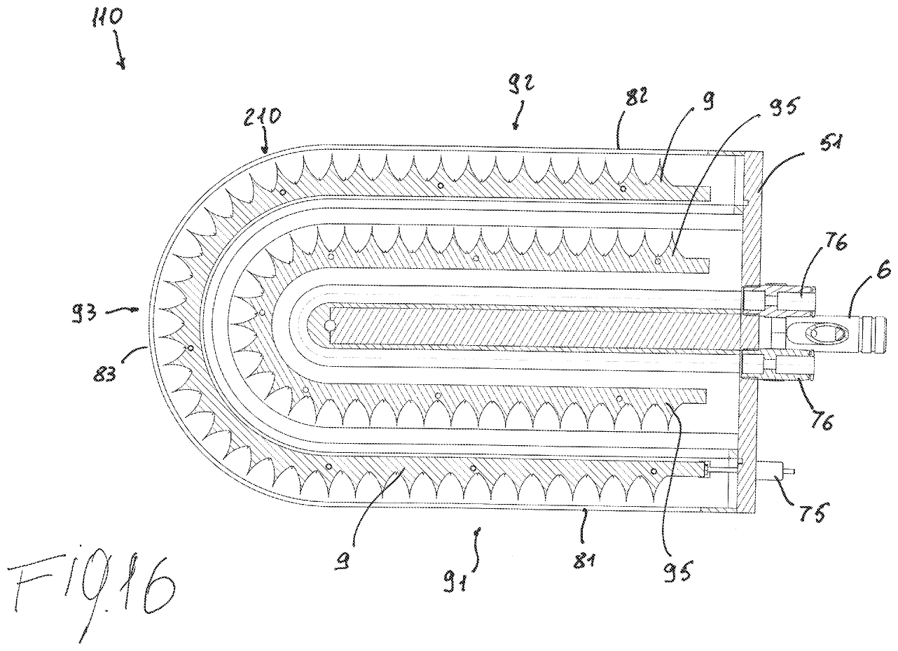

A particular embodiment of a device 110 as disclosed herein, illustrated in FIGS. 15 and 16, envisages that for each internal chamber of the shaped body 20 there are present, in addition to the electrodes 9 arranged at the slit 8, also a plurality of electrodes 95 arranged at the top of the internal chamber. In this case, the closing plate 51 of the various chambers is advantageously provided with a further intake duct 76 of cooling air at the plurality of electrodes 95. In the illustrated embodiment both the slit electrodes 9 and the internal electrodes 95 are formed by a serrated strip.

The shape and dimensions of the electrodes, both for this embodiment and more in general for any embodiment of a device as disclosed herein, can be very different depending on needs.

In general, as previously mentioned, given the modular structure of an electrostatic powder coating device as disclosed herein, it is possible to modulate in an extremely simple manner both the quantity of powder emitted from the slits 8, 81, 82, 83, and the electrical charge imparted to the powder. In fact, each slit 8, 81, 82, 83 is fed by an internal chamber 4, 41, 42, 43 thereof which can be operated independently of the others. It is therefore possible to activate/deactivate—or in any case modulate—the emission of powder coating from each of the internal chambers 4, 41, 42, 43 independently of each other, simply by activating/deactivating, or in any case modulating, the introduction of powder coating and air into each of them. Likewise, the polarisation of the powder coating emitted from each slit 8, 81, 82, 83 can be selectively activated/deactivated simply by activating/deactivating the power supply of the electrodes 9 positioned in each of them.

In practice, given that the quantity of powder which reaches and deposits on the artifact is determined by the aerodynamic and electrostatic forces in play, a device as disclosed herein may allow such forces to be better controlled through a modular control (i.e., for each internal chamber and corresponding slit, independently of the other chambers and slits) of the quantity and speed of the powder dispensed, as well as the amount of charge which is imparted to the powder particles.

For example, it has been seen that good results in terms of quantity and thickness homogeneity of the powder deposited even on artifacts with complex geometry, for example aluminium profiles, can be obtained by keeping the emission of powder coating active from all the slits 8, 81, 82, 83 and alternately keeping the electrodes in the intermediate slits off in an on/off/on/off sequence. In other words, in this case, in the vertical succession of slits 8, 81, 82, 83, the polarisation of the emitted powder is alternated.

Exemplary devices as disclosed herein may conveniently be applied in the coating stations of electrostatic powder coating systems.

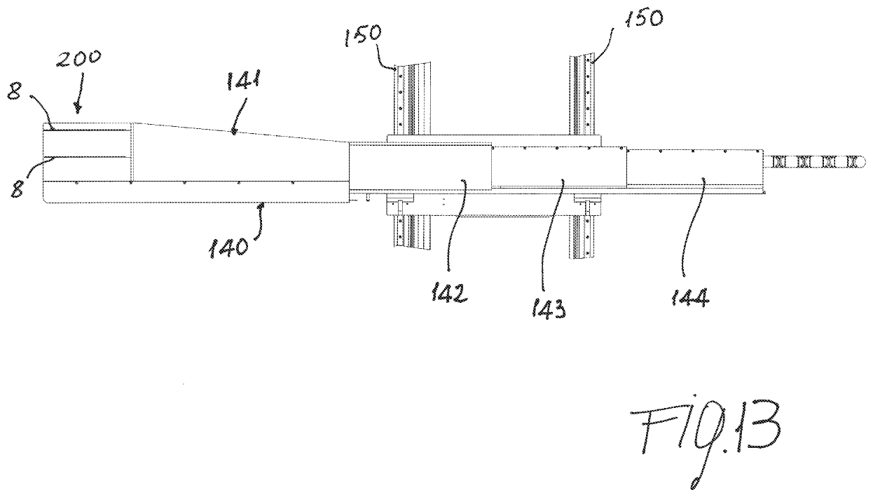

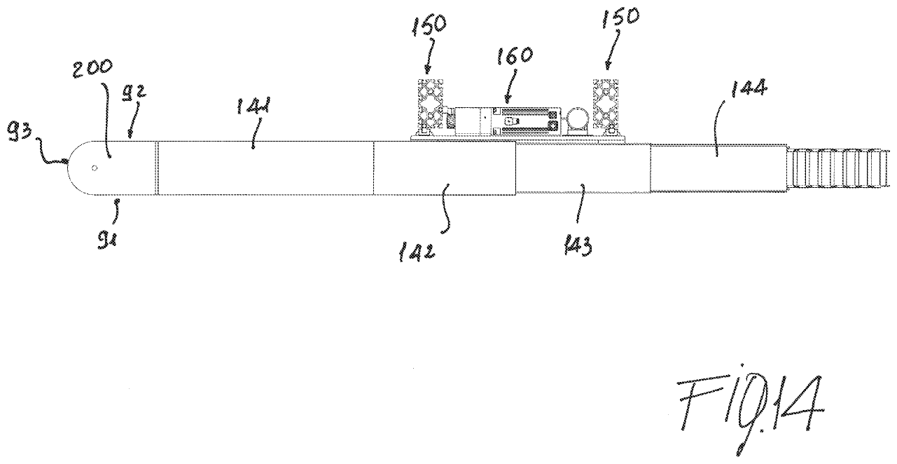

With reference to FIGS. 13 and 14, some details of a possible implementation of a device as disclosed herein are illustrated with respect to a coating station.

In this embodiment, the electrostatic powder coating device comprises a shaped body 200, having a first and a second internal chamber which are in communication with the outside by means of the respective slits 8. The shaped body 200 is mounted on a horizontal support 140 so that the slits 8 are substantially horizontal. The horizontal support 140 is in turn mounted on a pair of vertical uprights 150 and is operationally connected to movement means 160 (for example a reciprocator) which, in operating conditions, move the coating device continuously in a vertical direction and with alternating motion.

There is also a housing 141 for the voltage generators and any other devices on the horizontal support 140. In the illustrated embodiment, the horizontal support 140, and consequently the shaped body 200 of the coating device, are movable horizontally through the telescopic elements 142, 143 and 144.

In practice, from the illustrated position in which the coating device is inserted inside the coating station, it is possible to retract it outwards (to the right) by sliding the telescopic elements 142, 143 and 144 into each other towards the right.

Thanks to the use of a powder coating device as disclosed herein, the design of the coating booth is extremely compact and simplified with respect to the booths of known type.

In practice, inside the coating booth the overhead conveyor follows a U-shaped path of relatively short length around the coating device with a trend substantially parallel to the trend of the sides 91, 92 and the front wall 93 of the shaped body 200. Consequently, the artifacts to be coated are hit by the powder exiting the slits 8 along their entire path around the device.

If the artifacts need to be coated only on one side, this allows for relatively high transport speeds, given that the coating occurs continuously along the entire path. If the artifacts must be coated on both sides, it is possible to envisage a rotation of the artifacts at a point of the path located at approximately half of the front wall 93 of the shaped body 200. Thereby, the artifacts are coated on one side when they are facing the first side 91 and the first half of the front wall 93 of the shaped body 200 and, after rotation, they are coated on the opposite side when they are facing the second side 92 and the second half of the front wall 93 of the shaped body 200. Alternatively, according to an embodiment not illustrated in the Figures, if the artifacts must be coated on both sides, it is possible to envisage the use of a pair of coating devices arranged along the overhead conveyor which follows a substantially S-shaped path consisting of three straight sections connected by two curved sections, the coating devices being positioned opposite each other in the loops formed on the S-shaped path.

As can be seen from the description and the accompanying drawings, the technical solutions provided herein may allow the preset tasks and objects to be fully accomplished, obtaining a coating device of undoubted usefulness and practicality of use.

The various embodiments described herein are susceptible to numerous modifications and variations, all falling within the same innovative idea defined in the attached claims. In practice, the materials used, as well as the dimensions and contingent shapes, may be any according to needs and the state of the art.

What is claimed is:

1. An electrostatic powder coating device comprises:
a shaped body extending along a longitudinal axis and housing at least one internal chamber therein which is configured to contain a fluid bed of a powder coating;
a closing plate of the internal chamber transverse to the longitudinal axis and provided with a first intake duct of a powder coating into the internal chamber and a second intake duct of pressurized air into the internal chamber;
wherein the shaped body comprises:
a first lower element extending along the longitudinal axis of the shaped body and comprising a first surface defining a lower portion of the internal chamber;
a second upper element extending along the longitudinal axis of the shaped body and comprising a second surface defining an upper portion of the inner chamber;
the first lower element and the second upper element each being provided with a first and second peripheral edge, respectively, delimiting one or more slits putting the internal chamber in communication with the outside of the shaped body, a plurality of electrodes being arranged at the one or more slits and being connected to one or more voltage generators.

2. The electrostatic powder coating device of claim 1, wherein the shaped body comprises a first and a second substantially straight side which are opposite each other with respect to the longitudinal axis and parallel to each other and to the longitudinal axis, the first and second sides being connected to each other at one end by a front portion of the shaped body and being connected to the closing plate at an opposite end with respect to the front portion.

3. The electrostatic powder coating device of claim 2, wherein the front portion whereby the first and second sides are connected to each other comprises a curved portion of the shaped body.

4. The electrostatic powder coating device of claim 1, wherein:
the shaped body comprises one or more third intermediate elements, extending along the longitudinal axis of the shaped body and which is interposed between the first and second elements;
at least a third element is connected to the first element and defines a first internal chamber therewith and is provided with a third peripheral edge facing the first peripheral edge of the first element to form one or more slits which put the first internal chamber in communication with the outside of the shaped body; and
at least the third element and/or another element is connected to the second element and defines a second internal chamber therewith and is provided with a fourth peripheral edge facing the second peripheral edge of the second element to form one or more slits which put the second internal chamber in communication with the outside of the shaped body, a plurality of electrodes being arranged at the one or more slits and being connected to one or more voltage generators.

5. The electrostatic powder coating device of claim 4, wherein the at least a third intermediate element comprises:
a third surface defining an upper portion of the first internal chamber, the third surface being shaped in a similar manner to the second surface of the second upper element; and
a fourth surface defining a lower portion of the second internal chamber, the fourth surface being shaped in a similar manner to the first surface of the first lower element.

6. The electrostatic powder coating device of claim 4, wherein the shaped body comprises a plurality of the third intermediate elements, superimposed therebetween and coupled in succession so as to define a plurality of internal chambers of the shaped body provided with corresponding one or more slits.

7. The electrostatic powder coating device of claim 1, wherein the one or more slits of the internal chambers comprise a first and a second substantially straight slit portion positioned on the first and second sides of the shaped body.

8. The electrostatic powder coating device of claim 1, wherein the one or more slits of the internal chambers comprise a third slit portion positioned on the front portion of the shaped body.

9. The electrostatic powder coating device of claim 8, wherein the first, second, and third slit portions are connected to each other to form a continuous slit.

10. The electrostatic powder coating device of claim 1, wherein each of the internal chambers comprises a porous partition dividing them into a first and a second chamber portion, wherein the first intake duct of a powder coating is connected to the first chamber portion and the second intake duct of pressurized air is connected to the second chamber portion.

11. The electrostatic powder coating device of claim 1, wherein the closing plate of the internal chamber is provided with a third intake duct of air at the plurality of electrodes.

12. An electrostatic powder coating system, comprising:
a coating station equipped with an electrostatic powder coating device;
wherein the electrostatic powder coating device comprises:
a shaped body extending along a longitudinal axis and housing at least one internal chamber therein which is configured to contain a fluid bed of a powder coating;
a closing plate of the internal chamber transverse to the longitudinal axis and provided with a first intake duct of a powder coating into the internal chamber and a second intake duct of pressurized air into the internal chamber;
wherein the shaped body comprises:
a first lower element extending along the longitudinal axis of the shaped body and comprising a first surface defining a lower portion of the internal chamber;
a second upper element extending along the longitudinal axis of the shaped body and comprising a second surface defining an upper portion of the inner chamber;
the first lower element and the second upper element each being provided with a first and second peripheral edge, respectively, delimiting one or more slits putting the internal chamber in communication with the outside of the shaped body, a plurality of electrodes being arranged at the one or more slits and being connected to one or more voltage generators.

13. The electrostatic powder coating system of claim 12, wherein the shaped body comprises a first and a second substantially straight side which are opposite each other with respect to the longitudinal axis and parallel to each other and to the longitudinal axis, the first and second sides being connected to each other at one end by a front portion of the shaped body and being connected to the closing plate at an opposite end with respect to the front portion.

14. The electrostatic powder coating system of claim 12, wherein:
the shaped body comprises one or more third intermediate elements, extending along the longitudinal axis of the shaped body and which is interposed between the first and second elements;
at least a third element is connected to the first element and defines a first internal chamber therewith and is provided with a third peripheral edge facing the first peripheral edge of the first element to form one or more slits which put the first internal chamber in communication with the outside of the shaped body; and
at least the third element and/or another element is connected to the second element and defines a second internal chamber therewith and is provided with a fourth peripheral edge facing the second peripheral edge of the second element to form one or more slits which put the second internal chamber in communication with the outside of the shaped body, a plurality of electrodes being arranged at the one or more slits and being connected to one or more voltage generators.

15. The electrostatic powder coating system of claim 14, wherein the at least a third intermediate element comprises:
a third surface defining an upper portion of the first internal chamber, the third surface being shaped in a similar manner to the second surface of the second upper element; and
a fourth surface defining a lower portion of the second internal chamber, the fourth surface being shaped in a similar manner to the first surface of the first lower element.

16. The electrostatic powder coating system of claim 14, wherein the shaped body comprises a plurality of the third intermediate elements, superimposed therebetween and coupled in succession so as to define a plurality of internal chambers of the shaped body provided with corresponding one or more slits.

17. The electrostatic powder coating system of claim 12, wherein the one or more slits of the internal chambers comprise a first and a second substantially straight slit portion positioned on the first and second sides of the shaped body.

18. The electrostatic powder coating system of claim 12, wherein:
the one or more slits of the internal chambers comprise a third slit portion positioned on the front portion of the shaped body; and
the first, second, and third slit portions are connected to each other to form a continuous slit.

19. The electrostatic powder coating system of claim 12, wherein each of the internal chambers comprises a porous partition dividing them into a first and a second chamber portion, wherein the first intake duct of a powder coating is connected to the first chamber portion and the second intake duct of pressurized air is connected to the second chamber portion.

20. The electrostatic powder coating system of claim 12, wherein the closing plate of the internal chamber is provided with a third intake duct of air at the plurality of electrodes.
